(19) United States
(12) Patent Application Publication
(10) Pub. No.: US 2009/0033593 A1
(43) Pub. Date: Feb. 5, 2009

(54) Driving method of plasma display panel and plasma display apparatus

(76) Inventor: Ryo Nakano, Yokohama (JP)

Correspondence Address: MCDERMOTT WILL & EMERY LLP, 600 13TH STREET, N.W., WASHINGTON, DC, 20005-3096, US

(21) Appl. No.: 12/073,791

(22) Filed: Mar. 10, 2008

(30) Foreign Application Priority Data
Jul. 31, 2007 (JP) 2007-198642

(51) Int. Cl. G09G 3/28

(52) U.S. Cl. 345/60; 345/68; 345/204

(57) ABSTRACT

A plasma display apparatus can operate only the display operations requiring control for suppressing a temperature of a panel tube surface. In the plasma display apparatus, display load factors of display image data at each of a plurality of regions on a plasma display panel are detected by an individual-region display load factor detecting means 3. Then, as a variance value, differences between a display load factor of a whole screen and the display load factors of the respective regions are added up to the number of divided regions. The number of sustain pulses determined by a display load factor detected by the display image data and applied to the plasma display panel is controlled to be decreased by sustain pulse number control means when the variance value is more than a first value or falls within a range between the first value and a second value larger than the first value.

### CROSS-REFERENCE TO RELATED APPLICATION

The present application claims priority from Japanese Patent Application No. JP 2007-198642 filed on Jul. 31, 2007, the content of which is hereby incorporated by reference into this application.

### TECHNICAL FIELD OF THE INVENTION

The present invention relates to a plasma display apparatus, and in particular, to an effective technique applied to a method for preventing thermal destruction or burn-in of a plasma display panel.

### BACKGROUND OF THE INVENTION

Regarding a plasma display apparatus, the present inventor have studied, for example, a method for preventing thermal destruction or burn-in of a plasma display panel. There is such a proposed method in Japanese Patent Application Laid-Open Publication No. 2002-99242 (Patent Document 1) that the total number of times of light emission is monitored, and if states of light emission exceeding a given reference value occur more often than a predetermined frequency, the total number of times of the light emission is decreased, and if states of light emission falling below a given reference value occur less often than a predetermined frequency of light, the total number of times of the light emission is increased. Further, a method for optimally using the above-mentioned method has been also proposed in Japanese Patent Application Laid-Open Publication No. 2004-45886 (Patent Document 2).

### SUMMARY OF THE INVENTION

However, regarding a plasma display apparatus such as described above, in the methods of Patent Documents 1 and 2, while display operations which make a panel tube face high temperature require controls, other operations which do not require the controls are satisfied with conditions for the controls, so that the controls are also carried out. Therefore, it is necessary to separate the display operations in which the controls have to be operated due to rise in a temperature of the panel tube face from the other display operations.

In view of these circumstances, an object of the present invention is to provide a plasma display apparatus which can be worked with only the display operations to be controlled for suppressing a high temperature of the panel tube face.

The above and the other objects and a novel feature of the present invention will become apparent from the description of the present specification and the accompanying drawings.

A representative invention of the inventions disclosed in the present application will be briefly explained below.

The present invention is applied to a driving method of a plasma display panel and a plasma display apparatus. The invention is characterized by detecting display load factors of display image data at each of a plurality of regions on the plasma display panel; adding, as a variance value, differences between a display load factor of a whole screen and the display load factors of the respective regions up to the number of the divided regions; and controlling the number of sustain pulses determined by the display load factor detected from the display image data, being to be applied to the plasma display panel, so as to be decreased when the variance value is more than a first value or falls within a range between the first value and a second value larger than the first value.

Furthermore, the invention is characterized by producing a thermal variance value by multiplying the variance value by at least one subfield display load factor, and controlling the number of sustain pulses determined by the display load factor detected from the display image data, being to be applied to the plasma display panel, so as to be decreased when the thermal variance value is more than a third value or falls within a range between the third value and a fourth value larger than the third value.

An effect obtained by the representative one of the inventions disclosed in the present application will be briefly described below.

According to the present invention, since only the display operations requiring the control for suppressing a high temperature of the panel tube face can be worked, it becomes possible to prevent thermal destruction and burn-in of the plasma display panel.

### BRIEF DESCRIPTIONS OF THE DRAWINGS

FIG. 1 is a diagram showing an example of a configuration of a plasma display panel mounted on a plasma display apparatus according to a first embodiment of the present invention;

FIG. 2 is a diagram showing an example of a configuration of the plasma display apparatus according to the first embodiment of the present invention;

FIG. 3 is a diagram showing an example of a configuration of one field in the plasma display apparatus according to the first embodiment of the present invention;

FIG. 4A is a diagram showing an example of a driving waveform in the plasma display apparatus according to the first embodiment of the present invention;

FIG. 4B is a diagram showing an example of a driving waveform in the plasma display apparatus according to the first embodiment of the present invention;

FIG. 4C is a diagram showing an example of a driving waveform in the plasma display apparatus according to the first embodiment of the present invention;

FIG. 5 is a diagram showing an example of a configuration of a control circuit in the plasma display apparatus according to the first embodiment of the present invention;

FIG. 6 is a diagram showing an example of variance values which express differences between a display load factor of a whole screen and display load factors of respective divided regions of the screen in the plasma display apparatus according to the first embodiment of the present invention;

FIG. 7A is a diagram showing an example of a relation between a variance value and the number of sustain pulses in the plasma display apparatus according to the first embodiment of the present invention;

FIG. 7B is a diagram showing an example of a relation between a variance value and the number of sustain pulses in the plasma display apparatus according to the first embodiment of the present invention;

FIG. 8A is a diagram showing an example of a relation among a display load factor, the number of sustain pulses, and power in a conventional art;

FIG. 8B is a diagram showing an example of a relation between a window display load factor and luminance in a conventional art;

FIG. 9 is a diagram showing an example of a configuration of a control circuit in a plasma display apparatus according to a second embodiment of the present invention;

FIG. 10A is a diagram showing an example of a relation between a thermal variance value and the number of sustain pulses in the plasma display apparatus according to the second embodiment of the present invention;

FIG. 10B is a diagram showing an example of a relation between a thermal variance value and the number of sustain pulses in the plasma display apparatus according to the second embodiment of the present invention;

FIG. 11 is a diagram showing an example of a configuration of a control circuit in a plasma display apparatus according to a third embodiment of the present invention;

FIG. 12 is a diagram showing an example of a relation between time taking account of a variance value and the number of sustain pulses in the plasma display apparatus according to the third embodiment of the present invention;

FIG. 13 is a diagram showing an example of a configuration of a control circuit in a plasma display apparatus according to a fourth embodiment of the present invention;

FIG. 14 is a diagram showing an example of a relation between an airflow of a fan taking account of a variance value and the number of sustain pulses in the plasma display apparatus according to the fourth embodiment of the present invention;

FIG. 15 is a diagram showing an example of a configuration of a control circuit in a plasma display apparatus according to a fifth embodiment of the present invention and;

FIG. 16 is a diagram showing an example of a relation between an environmental temperature taking account of a variance value and the number of sustain pulses in the plasma display apparatus according to the fifth embodiment of the present invention.

### DESCRIPTIONS OF THE PREFERRED EMBODIMENTS

Embodiments of the present invention will be explained in detail below with reference to the drawings. Note that the same members are denoted by the same reference numerals in principle throughout all the drawings for explaining the embodiments and repeating explanation thereof are omitted.

### First Embodiment

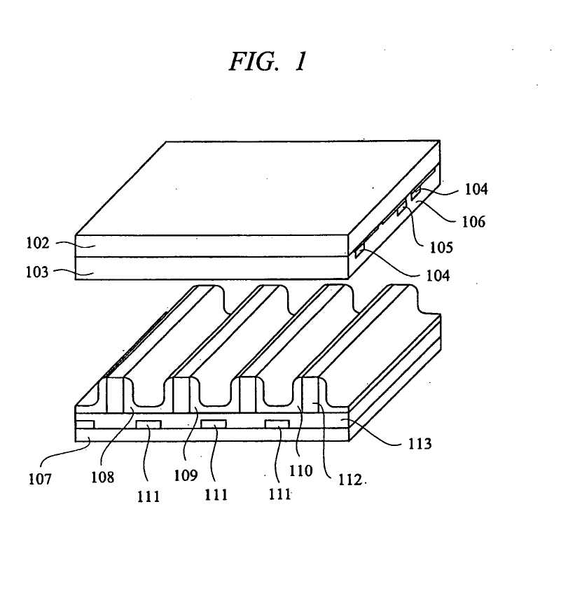

A first embodiment of a plasma display apparatus according to the present invention will be explained with reference to FIGS. 1 to 7.

FIG. 1 is a diagram showing an example of a configuration of a plasma display panel mounted on the plasma display apparatus according to the present embodiment.

The plasma display panel comprises a front face plate 102, a protective layer 103 for the front face plate, X electrodes 104, Y electrodes 105, a front face plate side dielectric layer 106, a back face plate 107, fluorescence substances 108, 109, and 110, address electrodes 111, barrier walls 112, a back face plate side dielectric layer 113, and the like.

The X electrodes 104 and the Y electrodes 105 which discharge repeatedly are disposed on the front face plate 102 in parallel at predetermined intervals. Each of X and Y electrodes 104 and 105 forms a pair with an adjacent electrode on one side thereof to discharge therebetween. Also, there may be such a structure that each electrode discharges between adjacent electrodes on both sides thereof. Each of X electrodes 104 and Y electrodes 105 is alternately disposed. Also, there is such a structure that the X electrodes 104 are disposed side by side on non-discharge sides and the Y electrodes 105 are disposed side by side on non-discharge sides. An electrode group of the X and Y electrodes 104 and 105 is covered with the front face plate side dielectric layer 106. A surface of the dielectric layer 106 is further covered with the protective layer 103 of MgO or other materials.

The address electrodes 111 are disposed on the back face plate 107 in a direction approximately perpendicular to the X electrodes 104 and the Y electrodes 105, and are further covered with the back face plate side dielectric layer 113. The barrier walls 112 are disposed on both sides of the address electrode 111 to separate cells in a column direction. The fluorescence substances 108, 109, and 110, which are excited by ultraviolet rays to emit visible light of red (R), green (G), and blue (B), are further applied to the back face plate side dielectric layers 113 above the address electrodes 111 and side faces of the barrier walls 112.

A plasma display panel is configured in a way the front face plate 102 and the back face plate 107 are attached to each other so that the protective layer 103 and the barrier walls 112 contact with each other to fill with discharge gas such as Ne—Xe. Incidentally, there is a structure where barrier walls for separating cells are deposed in a row direction.

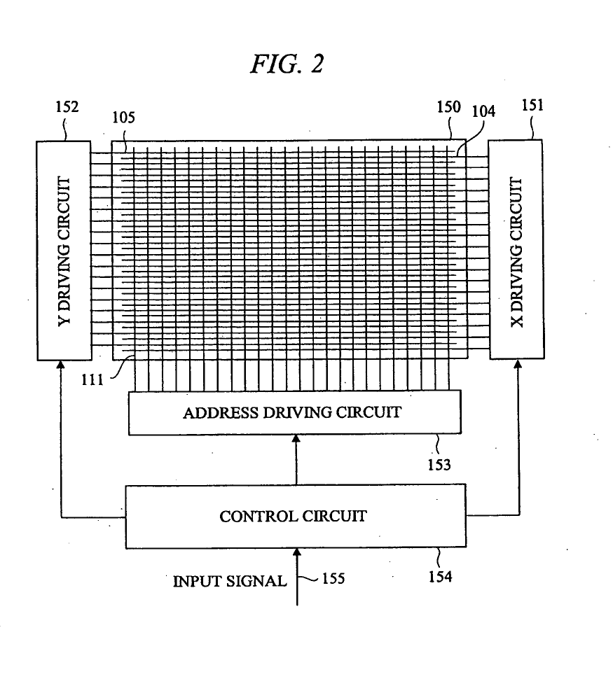

FIG. 2 is a diagram showing an example of a configuration of the plasma display apparatus according to the present embodiment.

The plasma display apparatus comprises: a plasma display panel 150 configured by attaching the front face plate 102 and back face plate 107 to each other; a driving circuit; a control circuit 154; and the like.

The plasma display panel 150 includes a plurality of electrode groups in which discharge is performed between two electrodes of the X electrode 104 and the Y electrode 105, and an electrode group of the address electrodes 111 disposed in a direction approximately perpendicular to the X electrodes 104 and the Y electrodes 105. A line formed by a pair of the X electrode 104 and the adjacent Y electrode 105 intersects with the address electrode 111 in order to form a cell corresponding to a region separated by the barrier walls 112. A pixel is configured by a set of cells of R, G, and B.

The driving circuit comprises: an X driving circuit 151 that applies a voltage to the electrode group of the X electrodes 104 for driving the X electrodes 104; a Y driving circuit 152 that applies a voltage to the electrode group of the Y electrodes 105 for driving the Y electrodes 105; and an address driving circuit 153 that applies a voltage to the electrode group of the address electrodes 111 for driving the address electrodes 111. The X electrodes 104, the Y electrodes 105, and the address electrodes 111 in the plasma display panel 150 are respectively connected to the X driving circuit 151, the Y driving circuit 152, and the address driving circuit 153. Also, the address driving circuits 153 may be disposed on both upper and lower sides of the plasma display panel 150.

The control circuit 154 is respectively connected to the X driving circuit 151, the Y driving circuit 152, and the address driving circuit 153 in order to control these driving circuits. An input signal 155 including display image data is inputted to the control circuit 154. Although the details will be described later, especially, the control circuit 154 has functions in which display load factors of a plurality of regions on the display panel 150 are detected; as a variance value, differences between a display load factor of the whole display and the display load factor of respective regions are added up to the number of the divided regions; and when the variance value is more than a first value, or falls within between the first value and a second value larger than the first value, the number of sustain pulses determined by the display load factor detected from the display image data, being to be applied to the plasma display panel 150, are decreased.

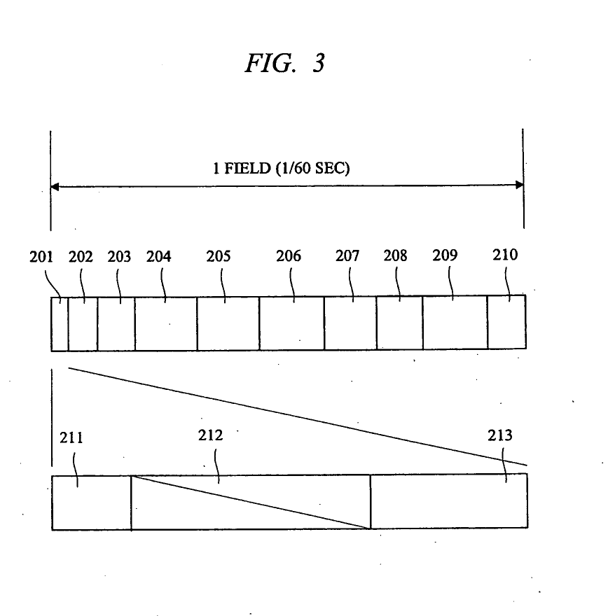

FIG. 3 is a diagram showing an example of a configuration of one field. In FIG. 3, a driving method on displaying one image (one field: 1/60 sec) is shown, which is an example of an address/display separation method.

One field is configured by a plurality of subfields (ten subfields 201 to 210 in this example). Each subfield comprises a reset period 211, an address period 212, and a sustain period 213. Control of charges in a cell is performed during the reset period 211 in order to assist discharge of the following address period 212, and the discharge for determining a cell to be emitted is performed during the address period 212. Repetitive discharges are performed to cause a cell to emit light during the following sustain period 213.

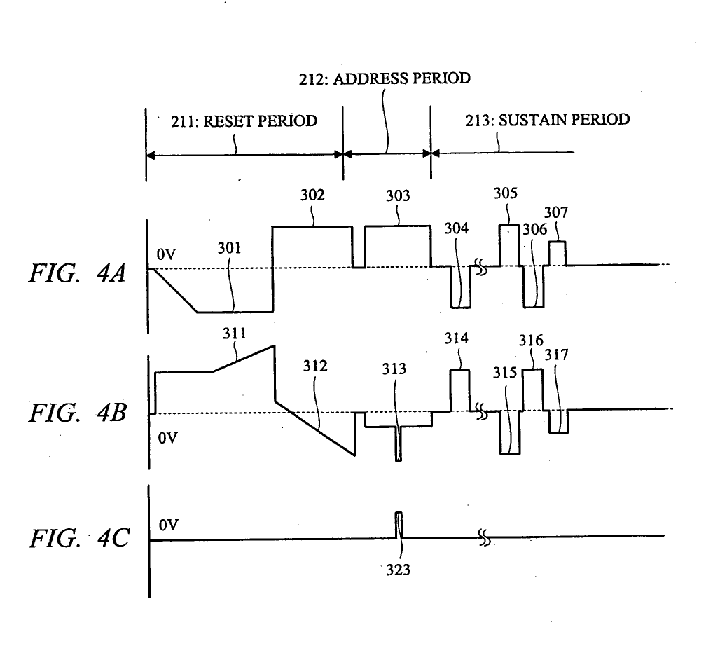

FIGS. 4A to 4B are diagrams showing an example of a driving waveform. Each of FIGS. 4A to 4C shows a driving waveform applied to the respective electrodes of the X electrode 104, the Y electrode 105, and the address electrode 111 for a time period from the reset period 211 to the sustain period 213. FIG. 4A shows a voltage waveform applied to the X electrode 104, FIG. 4B shows a voltage waveform applied to the Y electrode 105, and FIG. 4C shows a voltage waveform applied to the address electrode 111.

First, during the reset period 211, in order to form charges in all cells, a Y write slope wave 311 and an X voltage 301 are respectively applied to the X electrode 104 of FIG. 4A and the Y electrode 105 of 4C. Subsequently, in order to maintain the required amount of the charges formed in the cells and erase the other charges, a Y compensating slope wave 312 and an X compensating voltage 302 are applied to the X electrode 104 and the Y electrode 105.

Next, voltage waveforms applied during the following address period 212 are a Y electrode scanning pulse 313 applying to odd rows and causing discharge for determining cells to be displayed in a row direction, and a wall charge forming X voltage 303 for forming wall charges by this discharging. The Y electrode scanning pulse 313 is applied to each row in a way of shifting timing. At this time, an address electrode scanning pulse 323 is applied to the address electrode 111 of FIG. 4C.

Subsequently, first sustain pulses 304, 314, and repetitive sustain pulses 305, and 306, 315, and 316 are applied during the sustain period 213. Since the plasma display panel 150 according to the present embodiment is an example of an AC type plasma display panel, a set of discharging pulses with reversed polarities such as repetitive sustain pulses 305, 306, 315, and 316 is considered as a single sustain pulse for convenience. Finally, erasing pulses 307, 317 are applied.

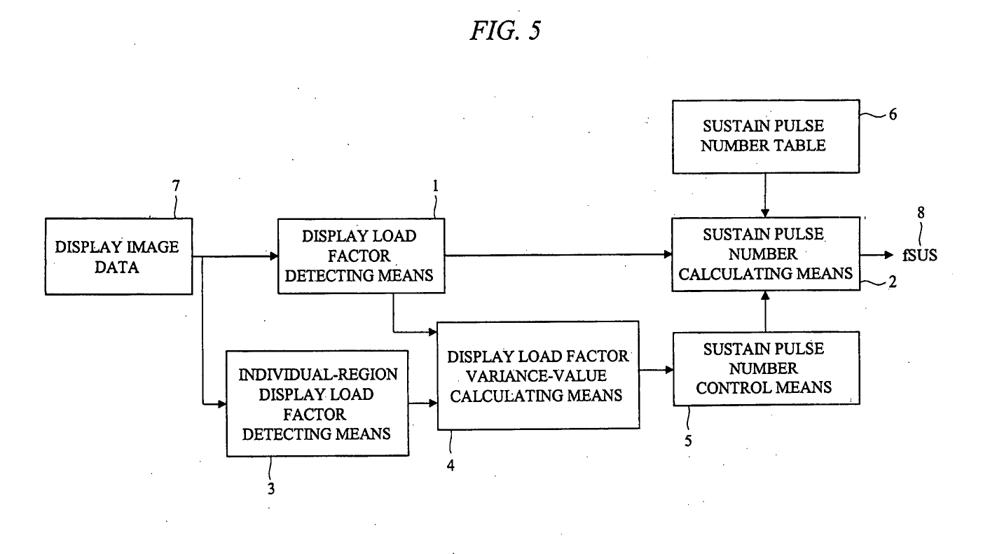

FIG. 5 is a diagram showing an example of a configuration of the above-mentioned control circuit 154.

The control circuit 154 comprises display load factor detecting means 1, sustain pulse number calculating means 2, individual-region display load factor detecting means 3, display load factor variance-value calculating means 4, sustain pulse number control means 5, a sustain pulse number table 6, and the like. Display image data 7 of the plasma display panel 150 is inputted to the control circuit 154, and detection/calculation/control are performed by the respective means, so that a sustain frequency (fSUS) 8 is outputted to the X driving circuit 151 and the Y driving circuit 152.

Although each of the means of the control circuit 154 is not limited to descriptions below, for example, the display load factor detecting means 1 and the individual-region display load factor detecting means 3 are realized by hardware, and the sustain pulse number calculating means 2, the display load factor variance-value calculating means 4, and the sustain pulse number control means 5 are realized by software executed by a CPU. Further, the sustain pulse number table 6 is provided on a memory accessible from the CPU, and is a correspondence table between the display load factor and the number of sustain pulses.

The display load factor detecting means 1 is a circuit that detects a display load factor of the display image data 7 when the display image data 7 of the plasma display panel 150 is inputted thereto. The display load factor is a value representing a ratio of cells to be lighted to the total number of cells on the screen.

The sustain pulse number calculating means 2 is a circuit in which when a display load factor detected by the display load factor detecting means 1 and a value of the sustain pulse number table 6 are inputted thereto, the number of sustain pulses to be applied to the plasma display panel 150 is calculated based on a relation among the display load factor, the display load factor of the sustain pulse number table 6, and the number of sustain pulses. In addition, the sustain pulse number calculating means 2 has a function in which when a control signal from the sustain pulse number control means 5 is also inputted thereto from the sustain pulse number control means 5, the number of sustain pulses, which is determined by calculating based upon the relation between the display load factor and the number of the sustain pulses, is calculated based upon the control signal inputted from the sustain pulse number control means 5. The number of sustain pulses calculated by the sustain pulse number calculating means 2 is outputted as the sustain frequency 8 to be applied to the plasma display panel 150.

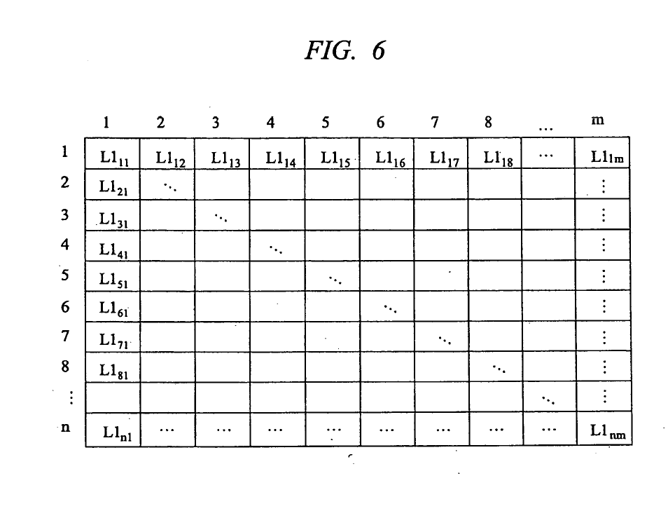

The individual-region display load factor detecting means 3 is a circuit in which when the display image data 7 is inputted thereto, display load factors of the display image data 7 are detected at each of a plurality of regions. The plurality of regions will be explained with reference to FIG. 6 described later.

The display load factor variance-value calculating means 4 is a circuit in which, when the display load factor of the whole screen of the display image data 7 detected by the display load factor detecting means 1 and the display load factors of the respective regions detected by the individual-region display load factor detecting means 3 are inputted thereto, the differences between the display load factor of the whole screen of the display image data 7 and the display load factors of the respective regions are added up to the number of the divided regions, as a variance value.

The sustain pulse number control means 5 is a circuit in which when the variance value calculated by the display load factor variance-value calculating means 4 is inputted thereto, and when the variance value is more than a first value or falls within a range between the first value and a second value larger than the first value, the number of sustain pulses, which is to be applied to the plasma display panel 150 and is determined by the display load factor detected from the display image data 7 by the display load factor detecting means 1, is controlled to be decreased. The control signal from the sustain pulse number control means 5 is inputted to the sustain pulse number calculating means 2.

In the control circuit 154 configured in the above manner, when the control circuit 154 controls the drive of the plasma display panel 150, the following procedure are conducted.

First, the display load factors of the display image data 7 at each of a plurality of regions on the plasma display panel 150 are detected by the individual-region display load factor detecting means 3. In this case, the display load factor of the whole screen of the display image data 7 is also detected by the display load factor detecting means 1. Further, as a variance value, differences between the display load factor of the whole screen of the display image data 7 detected by the display load factor detecting means 1 and the display load factors of the respective regions detected by the individual-region display load factor detecting means 3 are added up to the number of the divided regions by the display load factor variance-value calculating means 4.

Then, when the variance value calculated by the display load factor variance-value calculating means 4 is more than the first value or falls within a range between the first value and the second value, the number of sustain pulses, which is to be applied to the plasma display panel 150 and is determined by the display load factor detected by the display load factor detecting means 1, is controlled to be decreased. The number of sustain pulses determined by calculating based upon a relation among the display load factor detected by the display load factor detecting means 1, the display load factor of the sustain pulse number table 6, and the number of the sustain pulses is outputted, as the sustain frequency 8 to be applied to the plasma display panel 150, by the sustain pulse calculating means 2 based upon a control signal from the sustain pulse number control means 5.

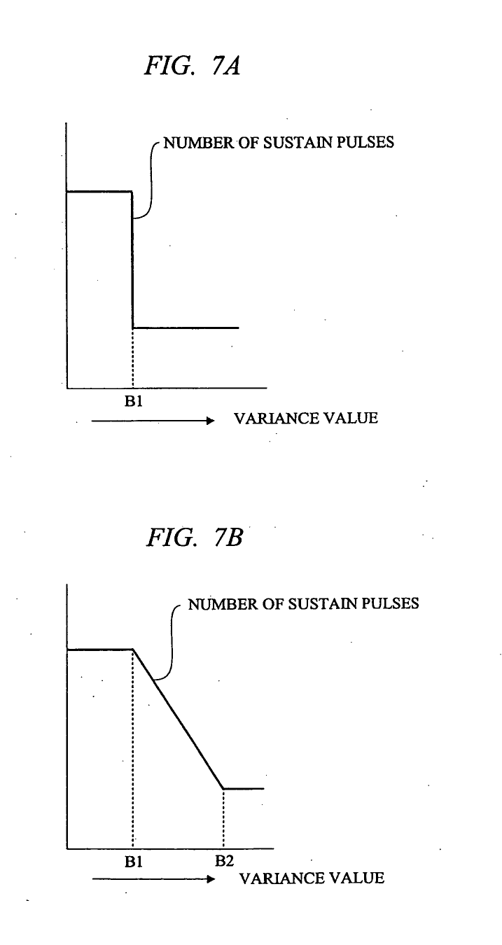

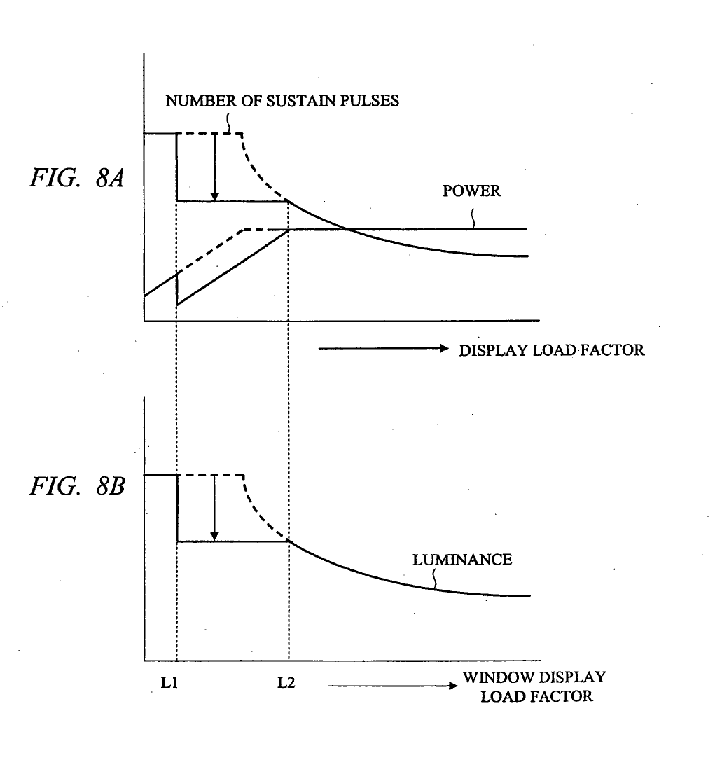

FIG. 6 is a diagram showing an example of a variance values which are differences between the display load factor of the whole screen and the display load factors of the respective regions. Each of FIGS. 7A and 7B shows an example of a relation between a variance value and the number of sustain pulses. FIG. 8A is a diagram showing an example of relation among a display load factor, the number of sustain pulses, and power. FIG. 8B is a diagram showing an example of a relation between a window display load factor and luminance, in the conventional art.

In the conventional arts (the above-mentioned Patent Documents 1 and 2), when such a state that the total number of sustain pulses maintain a large number occurs high-frequently, such determination is made that the possibility that patterns having small parts of high luminance are frequently displayed, so that the control is performed to decrease the total number of sustain pulses. Specifically, as shown in FIG. 8A, control for decreasing the number of sustain pulses (control from a broken line to a solid line) is conducted so that power is kept equal to or less than a predetermined value when the display load factor has become large. At this time, as shown in FIG. 8B, the luminance also decreases according to the decrease in the number of sustain pulses correspondingly.

In the control of the conventional art, in addition to display operations in which the control is required due to a high temperature of the panel tube face of the plasma display panel 150, some other display operations are satisfied with conditions for the control, so that the control is also carried out. Therefore, it is necessary to separate the display operations requiring the control due to rise in a temperature of the panel tube face from the other display operations. However, in the present embodiment, only the display operations requiring the control for suppressing a temperature of the panel tube face can be operated by applying a concept of the variance value explained in detail below.

FIG. 6 shows an example in which the whole screen is divided into n×m regions which are L1₁₁ to L1ₙₘ by dividing the vertical side of the whole screen into n parts and the lateral side of the whole screen into m parts. In this case, when assuming that the display load factor of the whole screen is L1, and the display load factors of the respective regions n×m obtained by dividing the whole screen are L1_{ab} (a=1 to n, and b=1 to m), the variance value is obtained by adding the differences up to the number of the divided regions, and is represented by the equation (1). Also, the variance value may be simply expressed by the equation (2).

$$\begin{matrix}Variance value = {\sum }_{a = 1}^{n} {\sum }_{b = 1}^{m} {( L 1 - L {1}_{ab} )}^{2} & Equation ( 1 ) \\ Variance value = {\sum }_{a = 1}^{n} {\sum }_{b = 1}^{m} \vert L 1 - L {1}_{ab} \vert & Equation ( 2 )\end{matrix}$$

Specifically, the panel tube face is divided into a plurality of regions (L1₁₁ to L1ₙₘ), and then the display load factors (L1_{ab} (a=1 to n and b=1 to m) of the respective regions are read. Then, differences between the display load factor (L1) of the whole region and the display load factors of the respective regions are added up to the number of the divided regions, whereby the variance value (equation (1) or equation (2)) is calculated, which is a magnitude of the bias with respect to the display load factor of the whole display. Considering the variance value as an index, only the display operations in which its variance value is larger than or equal to a predetermined threshold or is in a range of predetermined thresholds are controlled in order to decrease the number of the sustain pulses, so that only the display operations causing the overheat of the panel tubes face due to concentration of the loads can be controlled for the prevention of the overheat.

In the present embodiment, as shown in FIGS. 7A and 7B, the number of sustain pulses is decreased based upon the variance value. For example, as shown in FIG. 7A, when the variance value is more than a first value (B1) which is a fixed threshold, the number of sustain pulses, which is determined by the display load factor detected by the display load factor detecting means 1 and applied to the plasma display panel 150, is decreased in an L-shape. Alternatively, as shown in FIG. 7B, when the variance value falls within a range between the first value (B1) and a second value (B2) larger than the first value, which is in a predetermined range of fixed thresholds, the number of sustain pulses determined by the display load factor is linearly decreased with a predetermined slope. Besides, it is thought that the number of sustain pulses is decreased in a curved line, but it is needless to say that the way of decrease in the number of sustain pulses can be variously modified.

As described above, according to the plasma display apparatus of the present embodiment, when the variance value is more than the predetermined value, or falls within the predetermined range, the number of sustain pulses is controlled to be decreased, whereby only the display operations requiring control for suppressing a temperature of the panel tube face can be operated. As a result, it becomes possible to prevent thermal destruction or burn-in of the plasma display panel 150.

### Second Embodiment

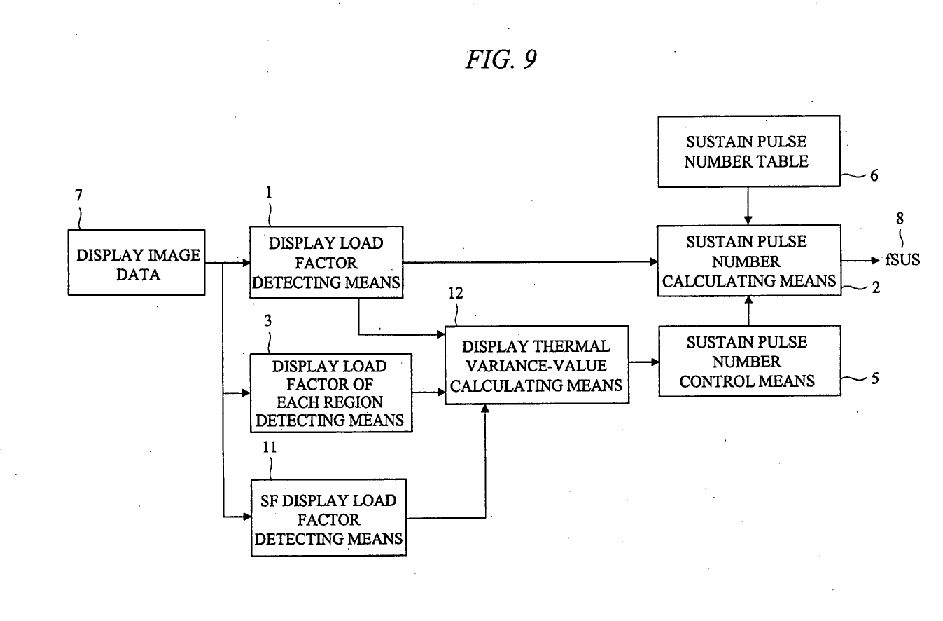

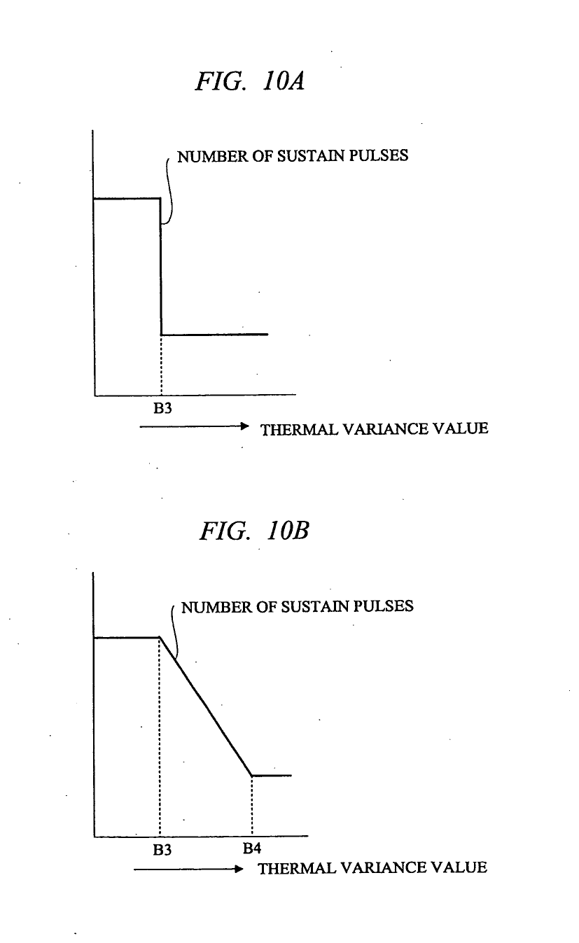

A plasma display apparatus according to a second embodiment of the present invention will be explained with reference to FIGS. 9 and 10.

In the plasma display apparatus according to the present embodiment, since a configuration of a plasma display panel, a configuration of a plasma display apparatus, a configuration of one field, and drive waveforms are the same as those shown in FIGS. 1, 2, 3, and 4 of the first embodiment, the explanations thereof are omitted here. In the present embodiment, only a configuration of a control circuit different from that of the first embodiment will be explained below. This description can be referred in third to fifth embodiments described later.

FIG. 9 is a diagram showing an example of a configuration of a control circuit in the plasma display apparatus according to the present embodiment.

A control circuit 154 comprises display load factor detecting means 1, sustain pulse number calculating means 2, individual-region display load factor detecting means 3, SF (subfield) display load factor detecting means 11, display thermal variance-value calculating means 12, sustain pulse number control means 5, a sustain pulse number table 6, and the like. In this the control circuit 154, the SF display load factor detecting means 11 is newly added to the configuration of the first embodiment shown in FIG. 5, and the display thermal variance-value calculating means 12 replaces the display load factor variance-value calculating means 4. These changes are mainly explained below.

The SF display load factor detecting means 11 is a circuit in which when display image data 7 is inputted thereto, an SF display load factor of the display image data 7 is detected. For example, it is realized by hardware.

The display thermal variance-value calculating means 12 is a circuit in which when the display load factor of a whole screen of the display image data 7 detected by the display load factor detecting means 1, the display load factors of respective regions detected by the individual-region display load factor detecting means 3, and the SF display load factor detected by the SF display load factor detecting means 11 are inputted thereto, differences between the display load factor of a whole screen of the display image data 7 and the display load factors of the respective regions are added up to the number of the divided regions, as a variance value, and a thermal variance value is obtained by multiplying the variance value by at least one SF display load factor detected by the SF display load factor detecting means 11. For example, it can be realized by software executed by a CPU.

The sustain pulse number control means 5 is a circuit in which when the thermal variance value calculated by the display thermal variance-value calculating means 12 is inputted thereto, also in the case where the thermal variance value is more than a third value, or falls within a range between the third value and a fourth value larger than the third value, the number of sustain pulses, which is determined by the display load factor detected from the display image date 7 by the display load factor detecting means 1 and applied to the plasma display panel 150, is controlled to be reduced.

In the control circuit 154, in order to control the drive of the plasma display panel 150, the SF display load factor of the display image data 7 is detected by the SF display load factor detecting means 11. Further, as a variance value, differences between the display load factor of the whole screen of the display image data 7 detected by the display load factor detecting means 1 and the display load factors of the respective regions detected by the individual-region display load factor detecting means 3 are added up to the number of the divided regions by the display thermal variance-value calculating means 12. Further, a thermal variance-value is obtained by multiplying the variance value by the SF display load factor detected by the SF display load factor detecting means 11. It is thought that a display load factor of the hottest SF or a display load factor derived from a plurality of SFs in order of the hotter is utilized as the SF display load factor.

When the thermal variance value calculated by the display thermal variance-value calculating means 12 is more than the third value, or falls within a range between the third value and the fourth value, the number of sustain pulses determined by the display load factor is controlled to be decreased by the sustain pulse number control means. The number of sustain pulses determined by calculating based upon a control signal from the sustain pulse number control means 5 by the sustain pulse number calculating means 2 is outputted as a sustain frequency 8 to be applied to the plasma display panel 150.

FIGS. 10A and 10B are diagrams showing examples of a relation between a thermal variance value and the number of sustain pulses.

In the present embodiment, as shown in FIGS. 10A and 10B, the number of sustain pulses is decreased based upon the thermal variance value. For example, as shown in FIG. 10A, when the thermal variance value is more than the third value (B3), the number of sustain pulses determined by the display load factor is decreased in an L-shape. As shown in FIG. 10B, when the thermal variance value falls within a range between the third value (B3) and the fourth value (B4) larger than the third value, the number of sustain pulses determined by the display load factor is linearly decreased with a predetermined slope. Besides, it is thought that the number of sustain pulses is decreased in a curved line, but it is needless to say that the way of decrease in the number of sustain pulses can be variously modified.

As described above, according to the plasma display apparatus of the present embodiment, when the thermal variance value is more than a predetermined value, or falls within a predetermined range, the number of sustain pulses is controlled to be decreased, whereby only the display operations requiring the control for suppressing a temperature of the panel tube face can be operated. As a result, it becomes possible to prevent thermal destruction or burn-in of the plasma display panel 150.

### Third Embodiment

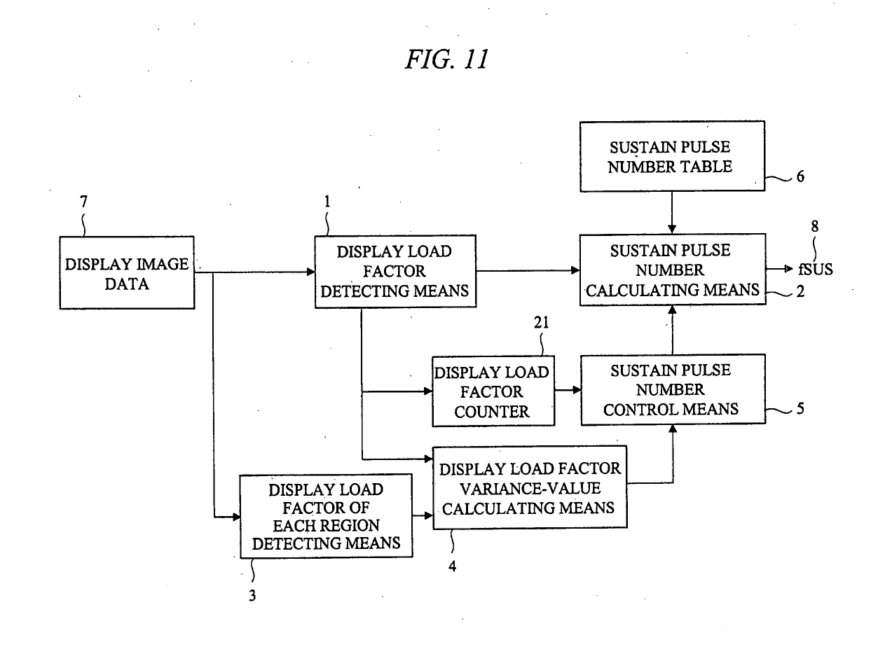

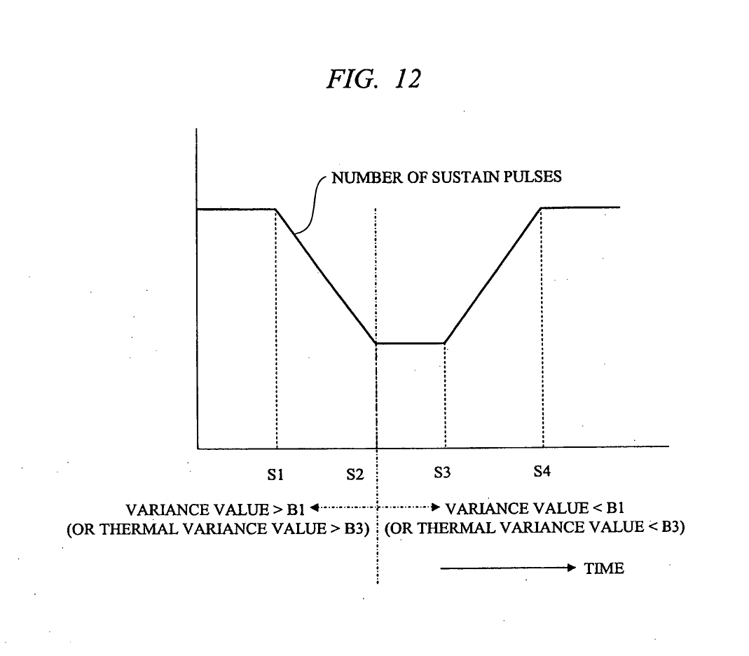

A plasma display apparatus according to a third embodiment of the present invention will be explained with reference to FIGS. 11 and 12.

FIG. 11 is a diagram showing an example of a configuration of a control circuit in the plasma display apparatus according to the present embodiment.

A control circuit 154 comprises display load factor detecting means 1, sustain pulse number calculating means 2, individual-region display load factor detecting means 3, display load factor variance-value calculating means 4, a display load factor counter 21, sustain pulse number control means 5, a sustain pulse number table 6, and the like. In this control circuit 154, the display load factor counter 21 is newly added to the configuration of the first embodiment shown in FIG. 5. This change is mainly explained below.

The display load factor counter 21 is a circuit in which when the display load factors detected by the display load factor detecting means 1 are inputted thereto, display load factors of the display image data 7 falling within a fixed range are counted. For example, it is realized by software executed by a CPU.

The sustain pulse number control means 5 is a circuit in which when the variance value calculated by the display load factor variance-value calculating means 4 and the display load factors falling within the fixed range counted by the display load factor counter 21 are inputted thereto, and when the variance value is more than the first value and the display load factor falling within the fixed range is continuously displayed for a fixed time or longer by the display load factor counter 21, the number of sustain pulses, which is determined by the display load factor detected from the display image data 7 by the display load factor detecting means 1 and applied to the plasma display panel 150, is controlled to be decreased.

In the control circuit 154, in order to control the drive of the plasma display panel 150, the display load factors of the display image data 7 falling within a fixed range are counted by the display load factor counter 21. Then, when the variance value calculated by the display load factor variance-value calculating means 4 is more than a first value and also the display load factor falling within the fixed range is continuously displayed for the fixed time or longer by the display load factor counter means 21, the number of sustain pulses determined by the display load factor is controlled to be decreased by the sustain pulse number control means 5. The number of sustain pulses by calculating based upon a control signal from the sustain pulse number control means 5 by the sustain pulse number calculating means 2 is outputted as a sustain frequency 8 to be applied to the plasma display panel 150.

FIG. 12 is a diagram showing an example of a relation between a time taking account of a variance value and the number of sustain pulses.

In the present embodiment, as shown in FIG. 12, the number of sustain pulses is decreased based upon the time taking account of the variance value. For example, as shown in FIG. 12, when the variance value is more than the first value (B1) and also the display load factor falling within the fixed range (between L1 to L2 in FIG. 8) is continuously displayed for the fixed time (S1) or longer by the display load factor counter 21, the number of sustain pulses determined by the display load factor is linearly decreased with a predetermined slope. Besides, it is thought that the number of sustain pulses is decreased in a curved line, but it is needless to say that the way of decrease in the number of sustain pulses can be variously modified.

As described above, according to the plasma display apparatus of the present invention, when the variance value is more than the predetermined value and also the display load factor falling within the fixed range is continuously displayed for the fixed time or longer by the display load factor counter 21, the number of sustain pulses is controlled to be decreased, whereby only the display operations requiring the control for suppressing a temperature of the panel tube face can be operated. As a result, it becomes possible to prevent thermal destruction or burn-in of the plasma display panel 150.

Incidentally, the present embodiment having the display load factor counter 21 is possible to be applied in the case where the thermal variance value is used instead of the variance value. In this case, as shown in FIG. 12, when the display load factor falling within the fixed range is continuously displayed for the fixed time (S1) or longer by the display load factor counter 21 in the state that the thermal variance value is more than the third value (B3), the number of pulses determined by the display load factor can be controlled to be decreased by the pulse number control means 5

### Fourth Embodiment

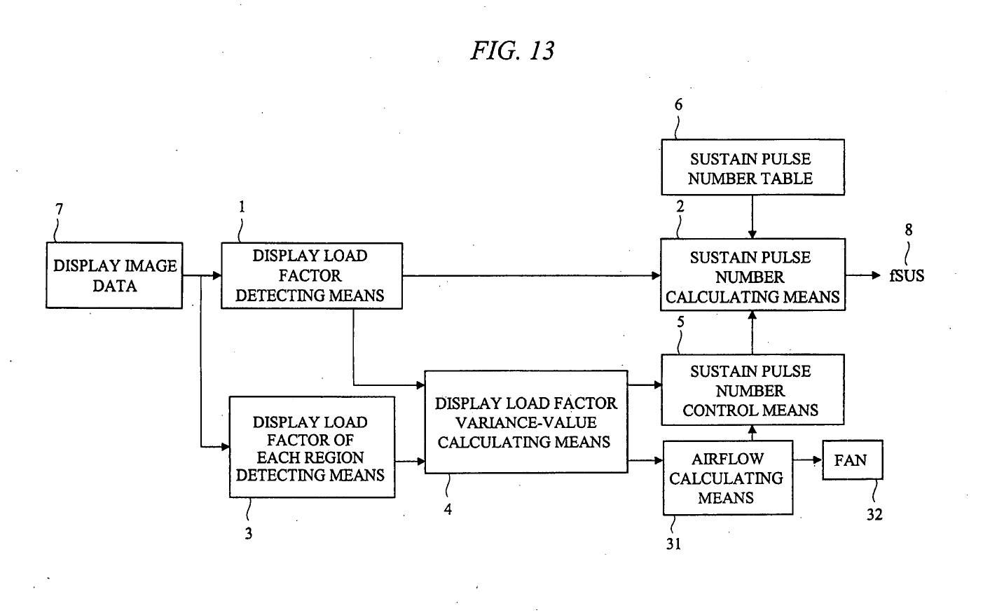

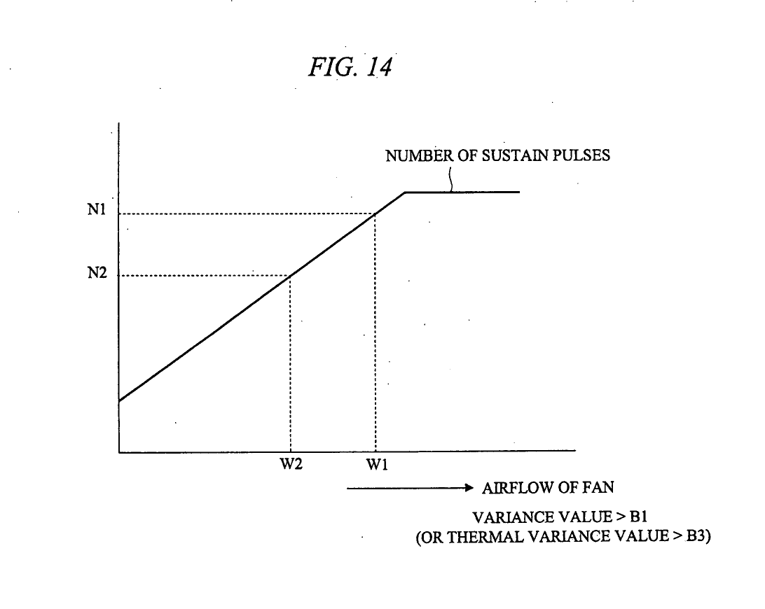

A plasma display apparatus according to a fourth embodiment of the present invention will be explained with reference to FIGS. 13 and 14.

FIG. 13 is a diagram showing an example of a configuration of a control circuit in the plasma display apparatus according to the present embodiment.

A control circuit 154 comprises display load factor detecting means 1, sustain pulse number calculating means 2, individual-region display load factor detecting means 3, display load factor variance-value calculating means 4, sustain pulse number control means 5, a sustain pulse number table 6, airflow calculating means 31, a fan 32 and the like. The control circuit 154 has such a configuration that the airflow calculating means 31 and the fan 32 are added to the configuration of the first embodiment shown in FIG. 5. These changes are mainly explained below.

The airflow calculating means 31 is a circuit in which when the variance value calculated by the display load factor variance-value calculating means 4 is inputted thereto, an airflow in the plasma display panel 150 is calculated. For example, it can be realized by software executed by a CPU.

A rotation number of the fan 32 is determined by the airflow calculated by the airflow calculating means 31. At least one fan 32 is disposed around the plasma display panel 150.

The sustain pulse number control means 5 is a circuit in which when the variance value calculated by the display load factor variance-value calculating means 4 and the airflow calculated by the airflow calculating means 31 are inputted thereto, in the case where airflows W1 and W2 calculated by the airflow calculating means 31 in the plasma display panel have a relation of W1>W2, and a relation of N1>N2 is established where the number of sustain pulses is N1 at the airflow W1 and the number of sustain pulses N2 at the airflow W2 due to the display load factor from the display image data by the display load factor detecting means, the sustain pulse number control means 5 is controlled to meet the relation of N1>N2 under the relation of W1>W2.

In the control circuit 154, in order to control the drive of the plasma display panel 150, an airflow in the plasma display panel 150 is calculated by the airflow calculating means 31. When airflows W1 and W2 calculated by the airflow calculating means 31 have a relation of W1>W2, and when a relation of N1>N2 is established where the number of sustain pulses is N1 at the airflow W1 and the number of sustain pulses is N2 at the airflow W2 due to the display load factor, the control circuit 154 is controlled to meet the relation of N1>N2 under the relation of W1>W2. The number of sustain pulses determined by calculating based upon a control signal form the sustain pulse number control means 5 is outputted as a sustain frequency 8 to be applied to the plasma display panel 150.

FIG. 14 is a diagram showing an example of a relation between an airflow taking account of a variance value and the number of sustain pulses.

In the present embodiment, as shown in FIG. 14, the number of sustain pulses is controlled based upon an airflow of the fan 32 taking account of the variance value (variance value>B1). For example, as shown in FIG. 14, when the airflow has a relation of W1>W2 and the number of sustain pulses has a relation of N1>N2, the control is performed so as to meet the relation of N1>N2 under the relation of W1>W2.

As described above, according to the plasma display apparatus of the present embodiment, the relation between the airflow of the fan 32 and the number of the sustain pulses is controlled to meet the relation of N1>N2 under the relation of W1>W2, whereby only the display operations requiring the control for suppressing a temperature the panel tube face can be operated. As a result, it becomes possible to prevent thermal destruction or burn-in of the plasma display panel 150.

Incidentally, the control based upon the airflow of the fan 32 like the present embodiment is possible to be applied in the case where the thermal variance value is used instead of the variance value. In this case, as shown in FIG. 14, the sustain pulse number control means 5 can control the number of sustain pulses based upon the airflow of the fan 32 taking account of the thermal variance value (thermal variance value>B3).

### Fifth Embodiment

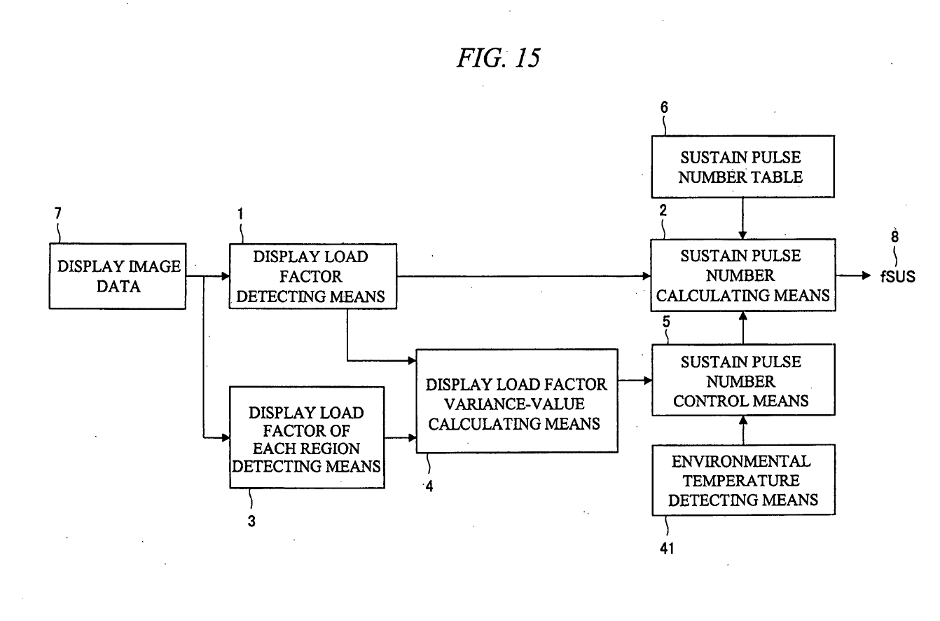

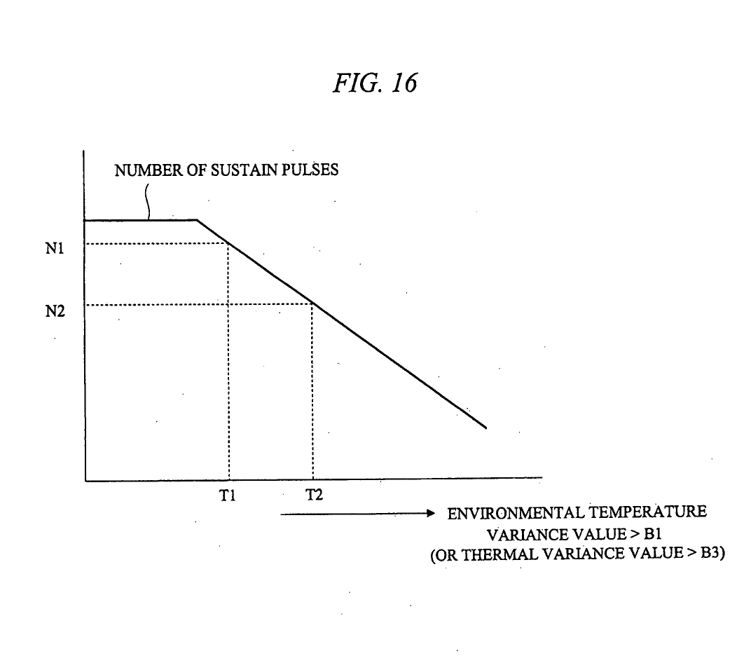

A plasma display apparatus according to a fifth embodiment of the present invention will be explained with reference to FIGS. 15 and 16.

FIG. 15 is a diagram showing an example of a configuration of a control circuit in a plasma display apparatus of the present embodiment.

A control circuit 154 comprises display load factor detecting means 1, sustain pulse number calculating means 2, individual-region display load factor detecting means 3, display load factor variance-value calculating means 4, sustain pulse number control means 5, a sustain pulse number table 6, environmental temperature detecting means 41, and the like. The control circuit 154 has such a configuration that the environmental temperature detecting means 41 is added to the configuration of the first embodiment shown in FIG. 5. This change is mainly explained below.

The environmental temperature detecting means 41 is a circuit which detects an environmental temperature in the plasma display panel 150. As the environmental temperature detecting means 41, at least one temperature sensor is disposed around the plasma display panel 150.

The sustain pulse number control means 5 is a circuit in which when the variance value calculated by the display load factor variance-value calculating means 4 and the environmental temperature detected by the environmental temperature detecting means 41 are inputted thereto, in the case where environmental temperatures T1 and T2 in the plasma display panel 150 detected by the environmental temperature detecting means 41 have a relation of T1<T2, and a relation of N1≧N2 is established where the number of sustain pulses is N1 at the environmental temperature T1 and the number of sustain pulses N1 at the environmental temperature T2 due to the display load factor detected from the display image data 7 by the display load factor detecting means 1, the sustain pulse number control means 5 is controlled to meet the relation of N1≧N2 under the relation of T1<T2.

In the control circuit 154, in order to control the drive of the plasma display panel 150, the environmental temperature in the plasma display panel 150 is detected by the environmental temperature detecting means 41. When the environmental temperatures T1 and T2 detected by the environmental temperature detecting means 41 have the relation of T1<T2, and the relation of N1≧N2 is established where the number of sustain pulses is N1 at the environmental temperature T1 and the number of sustain pulses is N2 at the environmental temperature T2 due to the display load factor, the control circuit 154 is controlled to meet the relation of N1≧N2 under the relation of T1≦T2. The number of the sustain pulses determined by calculating based upon the control signal from the sustain pulse number control means 5 by the sustain pulse number calculating means 2 is outputted as a sustain frequency 8 to be applied to the plasma display panel 150.

FIG. 16 is a diagram showing an example of a relation between an environmental temperature taking account of a variance value and the number of sustain pulses.

In the present embodiment, as shown in FIG. 16, the number of sustain pulses is controlled based upon the environmental temperature taking account of the variance value (variance value>B1). For example, as shown in FIG. 16, when the environmental temperatures have a relation of T1<T2 and the numbers of sustain pulses have a relation of N1≧N2, the control is performed so as to meet the relation of N1≧N2 under the relation of T1<T2.

As described above, according to the plasma display apparatus of the present embodiment, the relation between the environmental temperature and the number of sustain pulses is controlled to meet the relation of N1≧N2 under the relation of T1<T2. As a result, it becomes possible to prevent thermal destruction or burn-in of the plasma display panel 150.

Incidentally, the control based upon an environmental temperature like the present embodiment is possible to be applied in the case where the thermal variance value is used instead of the variance value. In this case, as shown in FIG. 16, the sustain pulse number control means 5 can control the number of sustain pulses based upon the environmental temperature taking account of the thermal variance value (thermal variance value>B3).

The invention which has been made by the present inventor has been concretely explained based upon the embodiments, but the present invention is not limited to the embodiments and may be variously modified without departing from the gist of the present invention.

The present invention relates to a plasma display apparatus and, in particular, can be utilized in a method for preventing thermal destruction or burn-in of a plasma display panel.

What is claimed is:

1. A driving method of a plasma display panel in a plasma display apparatus comprising the plasma display panel having a plurality of electrode groups in which discharge is performed between two electrodes, a driving circuit applying a voltage to the electrode groups of the plasma display panel to drive, and a control circuit controlling the driving circuit, the driving method comprising the step being executed by the control circuit,
wherein the control circuit detects display load factors of display image data at each of a plurality of regions on the plasma display panel; adds, as a variance value, differences between a display load factor of a whole screen and the display load factors of the respective regions up to the number of the divided regions; and controls the number of sustain pulses, which is determined by the display load factor detected from the display image data and is to be applied to the plasma display panel, so as to be decreased when the variance value is more than a first value or falls within a range between the first value and a second value larger than the first value.

2. The driving method of a plasma display panel according to claim 1,
wherein the control circuit produces a thermal variance value by multiplying the variance value by at least one subfield display load factor, and controls the number of sustain pulses, which is determined by the display load factor detected from the display image data and is to be applied to the plasma display panel, so as to be decreased when the thermal variance value is more than a third value or falls within a range between the third value and a fourth value larger than the third value.

3. The driving method of a plasma display panel according to claim 2,
Wherein the control circuit controls the number of sustain pulses, which is determined by the display load factor detected from the display image data and is to applied to the plasma display panel, so as to be decreased when the variance value is more than the first value or the thermal variance value is more than the third value and when a display load factor falling within a fixed range is continuously displayed for a fixed time or longer.

4. The driving method of a plasma display panel according to claim 1,
wherein when airflows W1 and W2 in the plasma display panel have a relation of W1>W2, and when a relation of N1>N2 is established where the number of sustain pulses is N1 at the airflow W1 and the number of sustain pulses is N2 at the airflow W2 due to the display load factor detected from the display image data, the control circuit is controlled to meet the relation of N1>N2 under the relation of W1>W2.

5. The driving method of a plasma display panel according to claim 1,
wherein when environmental temperatures T1 and T2 in the plasma display panel have a relation of T1<T2, and when a relation of N1≧N2 is established where the number of sustain pulses is N1 at the environmental temperature T1 and the number of sustain pulses is N2 at the environmental temperature T2 due to the display load factor detected from the display image data, the control circuit is controlled to meet the relation of N1≧N2 under the relation of T1<T2.

6. A plasma display apparatus comprising:
a plasma display panel having a plurality of electrode groups in which discharge is performed between two electrodes;
a driving circuit applying a voltage to the electrode groups of the plasma display panel to drive; and
a control circuit controlling the driving circuit,
wherein the control circuit comprises:
display load factor detecting means for detecting a display load factor of display image data in the plasma display panel;
sustain pulse number calculating means for calculating the number of sustain pulses to be applied to the plasma display panel;
individual-region display load factor detecting means for detecting display load factors of the display image data at each of a plurality of regions;
display load factor variance-value calculating means for adding, as a variance value, differences between a display load factor of a whole screen of the display image data and the load factors of the respective regions detected by the individual-region display load factor detecting means up to the number of divided regions; and
sustain pulse number control means for controlling the number of sustain pulses, which is determined by the display load factor detected from the display image data by the display load factor detecting means and is to be applied to the plasma display panel, so as to be decreased when the variance value calculated by the display load factor variance-value calculating means is more than a first value or falls within a range between the first value and a second value larger than the first value.

7. The plasma display apparatus according to claim 6,
wherein the control circuit further comprises display thermal variance-value calculating means for producing a thermal variance value by multiplying the variance value by at least one subfield display load factor, and
the sustain pulse number control means controls the number of sustain pulses, which is determined by the display load factor detected from the display image data by the display load factor detecting means and is to be applied to the plasma display panel, so as to be decreased when the thermal variance value obtained by the display thermal variance-value calculating means is more than a third value or falls within a range between the third value and a fourth value larger than the third value.

8. The plasma display apparatus according to claim 7,
wherein the control circuit further comprises a display load factor counter for counting the number of display load factors falling within a fixed range in the display image data, and
the sustain pulse number control means controls the number of sustain pulses, which is determined by the display load factor detected from the display image data by the display load factor detecting means and is to be applied to the plasma display panel, so as to be decreased when the variance value is more than the first value or the thermal variance value is more than the third value and when the display load factor falling within a fixed range is continuously displayed for a fixed time or longer by the display load factor counter.

9. The plasma display apparatus according to claim 6,
wherein the control circuit further comprises airflow calculating means for calculating an airflow in the plasma display panel to determine the rotation number of a fan, and
when airflows W1 and W2 calculated by the airflow calculating means in the plasma display panel have a relation of W1>W2, and when a relation of N1>N2 is established where the number of sustain pulses is N1 at the airflow W1 and the number of sustain pulses is N2 at the airflow W2 due to the display load factor detected from the display image data by the display load factor detecting means, the sustain pulse number control means is controlled to meet the relation of N1>N2 under the relation of W1>W2.

10. The plasma display apparatus according to claim 6,
wherein the control circuit further comprises environmental temperature detecting means for detecting an environmental temperature in the plasma display panel, and
when environmental temperatures T1 and T2 detected by the environmental temperature detecting means in the plasma display panel have a relation of T1<T2, and when a relation of N1≧N2 is established where the number of sustain pulses is N1 at the environmental temperature T1 and the number of sustain pulses is N2 at the environmental temperature T2 due to the display load factor detected from the display image data by the display load factor detecting means, the sustain pulse number control means is controlled to meet the relation of N1≧N2 under the relation of T1<T2.

11. The driving method of a plasma display panel according to claim 2,
wherein when airflows W1 and W2 in the plasma display panel have a relation of W1>W2, and when a relation of N1>N2 is established where the number of sustain pulses is N1 at the airflow W1 and the number of sustain pulses is N2 at the airflow W2 due to the display load factor detected from the display image data, the control circuit is controlled to meet the relation of N1>N2 under the relation of W1>W2.

12. The driving method of a plasma display panel according to claim 2,
wherein when environmental temperatures T1 and T2 in the plasma display panel have a relation of T1<T2, and when a relation of N1≧N2 is established where the number of sustain pulses is N1 at the environmental temperature T1 and the number of sustain pulses is N2 at the environmental temperature T2 due to the display load factor detected from the display image data, the control circuit is controlled to meet the relation of N1≧N2 under the relation of T1<T2.

13. The plasma display apparatus according to claim 7,
wherein the control circuit further comprises airflow calculating means for calculating an airflow in the plasma display panel to determine the rotation number of a fan, and
when airflows W1 and W2 calculated by the airflow calculating means in the plasma display panel have a relation of W1>W2, and when a relation of N1>N2 is established where the number of sustain pulses is N1 at the airflow W1 and the number of sustain pulses is N2 at the airflow W2 due to the display load factor detected from the display image data by the display load factor detecting means, the sustain pulse number control means is controlled to meet the relation of N1>N2 under the relation of W1>W2.

14. The plasma display apparatus according to claim 7,
wherein the control circuit further comprises environmental temperature detecting means for detecting an environmental temperature in the plasma display panel, and
when environmental temperatures T1 and T2 detected by the environmental temperature detecting means in the plasma display panel have a relation of T1<T2, and when a relation of N1≧N2 is established where the number of sustain pulses is N1 at the environmental temperature T1 and the number of sustain pulses is N2 at the environmental temperature T2 due to the display load factor detected from the display image data by the display load factor detecting means, the sustain pulse number control means is controlled to meet the relation of N1≧N2 under the relation of T1<T2.
